(19) United States
(12) Patent Application Publication
(10) Pub. No.: US 2025/0050871 A1
(43) Pub. Date: Feb. 13, 2025

(54) ASSISTANCE APPARATUS, VEHICLE, COMPUTER READABLE STORAGE MEDIUM, AND ASSISTANCE METHOD

(71) Applicant: HONDA MOTOR CO.,LTD., Tokyo (JP)

(72) Inventor: Masaharu SHINAGAWA, Tokyo (JP)

(21) Appl. No.: 18/796,327

(22) Filed: Aug. 7, 2024

(30) Foreign Application Priority Data
Aug. 10, 2023 (JP) 2023-130865

(51) Int. Cl. B60W 30/085; H04W 4/46

(52) U.S. Cl. CPC B60W 30/085; H04W 4/46; B60W 2554/805

(57) ABSTRACT

An assistance apparatus includes: a receiving unit which receives information indicating a travelling hazardous point which is transmitted from an outside of a vehicle; a calculating unit which calculates a distance and an azimuth from the vehicle to the travelling hazardous point based on the travelling hazardous point and a current location of the vehicle; a detecting unit which detects the travelling hazardous point within a range of detection set ahead of the vehicle in a running direction; an assistance controlling unit which provides travelling assistance when the travelling hazardous point is detected within the range of detection; a turning detecting unit which detects that the vehicle is turning; and a range changing unit which extends the range of detection in a turning direction of the vehicle when it is detected by the turning detecting unit that the vehicle is turning.

The contents of the following patent application(s) are incorporated herein by reference: NO. 2023-130865 filed in JP on Aug. 10, 2023.

### BACKGROUND

### 1. Technical Field

The present invention relates to an assistance apparatus, a vehicle, a computer readable storage medium, and an assistance method.

### 2. Related Art

In recent years, efforts have been intensified to provide access to a sustainable transportation system with consideration given to even vulnerable people among other traffic participants. To this end, research and development has been focused on to even further improve traffic safety or convenience through research and development regarding a driving assistance technology. Patent Documents 1 and 2 describe a technique regarding a range where an object or another vehicle is to be detected.

### PRIOR ART DOCUMENT

### Patent Document

Patent Document 1: Japanese Patent Application Publication No. 2015-45622
Patent Document 2: Japanese Patent Application Publication No. 2011-253241

### BRIEF DESCRIPTION OF THE DRAWINGS

FIG. 1 schematically shows a usage scene of an assistance apparatus 40 according to one embodiment.

FIG. 2 shows a range of detection 120 which is set when a vehicle 20 is travelling on a curved road 72.

FIG. 3 shows a system configuration of a vehicle 20.

FIG. 4 is a diagram for describing a first range of detection 100 which is set when a vehicle 20 is travelling straight.

FIG. 5 is a diagram for describing a range of detection 120 which is set when a vehicle 20 is turning.

FIG. 6 shows one example of a flowchart regarding an assistance method executed by an assistance apparatus 40.

FIG. 7 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solving means of the invention.

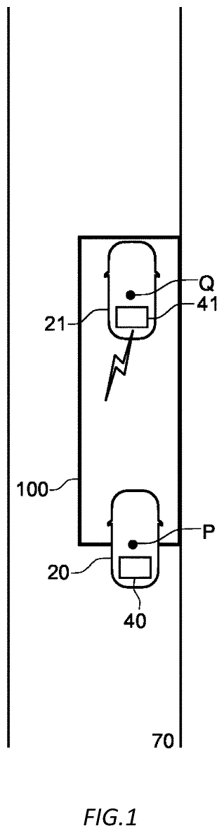

FIG. 1 schematically shows a usage scene of an assistance apparatus 40 according to one embodiment. A vehicle 20 includes the assistance apparatus 40. A vehicle 21 includes an assistance apparatus 41. The assistance apparatus 40 and the assistance apparatus 41 have travelling assistance functions of performing control regarding travelling assistance for their respective vehicles.

The vehicle 21 is a preceding vehicle which travels ahead of the vehicle 20 on a running route. The assistance apparatus 40 and the assistance apparatus 41 can transmit, to another vehicle, travelling hazardous point information indicating a point which may be hazardous to another vehicle for travelling.

The present embodiment describes a configuration in which the assistance apparatus 40 performs the control regarding the travelling assistance for the vehicle 20 when receiving the travelling hazardous point information transmitted by the assistance apparatus 41. For example, when magnitude of deceleration of the vehicle 21 exceeds a predetermined value, the assistance apparatus 41 may transmit, to a neighboring vehicle, the travelling hazardous point information indicating a point where the magnitude of the deceleration exceeds the predetermined value. The travelling hazardous point information may be, for example, a message for an emergency electronic brake light (EEBL). When it is detected that the vehicle 21 has slipped, the assistance apparatus 41 may transmit, to the neighboring vehicle, the travelling hazardous point information indicating a point where the vehicle 21 has slipped. The travelling assistance may be, for example, a warning regarding the presence of an object which will pose an obstacle to the vehicle for travelling (for example, a warning to the effect that there is a vehicle ahead, a warning regarding an accident vehicle or a disabled vehicle (PCW), or the like). The travelling hazardous point information may be information transmitted from a server other than another vehicle to the assistance apparatus 40.

In FIG. 1, when the vehicle 21 rapidly decelerates while travelling, the assistance apparatus 41 transmits, to the neighboring vehicle as the travelling hazardous point information, a point Q where the rapid deceleration has occurred. The travelling hazardous point information may include, for example, latitude and longitude information and speed information on the point where the vehicle has rapidly decelerated.

It is assumed that the vehicle 20 is travelling on a straight road 70. When receiving the travelling hazardous point information, the assistance apparatus 40 sets a first range of detection 100 which is a range where a travelling hazardous point is to be detected. The first range of detection 100 is a range which is located ahead of the vehicle 20 along a running direction of the vehicle 20 from a current location P of the vehicle 20. The first range of detection 100 is, for example, a rectangular range.

The assistance apparatus 40 provides the travelling assistance when the travelling hazardous point indicated by the received travelling hazardous point information is within the first range of detection 100. As shown in FIG. 1, since the point Q as the travelling hazardous point is within the first range of detection 100, the assistance apparatus 40 provides the travelling assistance. The assistance apparatus 40 may not provide the travelling assistance when the travelling hazardous point is not within the range of detection, and may provide the travelling assistance when the travelling hazardous point enters the range of detection as the vehicle 20 moves.

When providing the travelling assistance, even if the assistance apparatus 40 receives new travelling hazardous point information from another vehicle, the assistance apparatus 40 may continue to provide the travelling assistance and avoid providing travelling assistance which is based on information indicating the new travelling hazardous point until the vehicle 20 passes the point Q.

When the travelling hazardous point is sensed, the assistance apparatus 40 may transmit, to an outside of the vehicle 20, the travelling hazardous point information indicating the sensed travelling hazardous point. When the travelling hazardous point is sensed, the assistance apparatus 40 may avoid providing the travelling assistance for the vehicle 20.

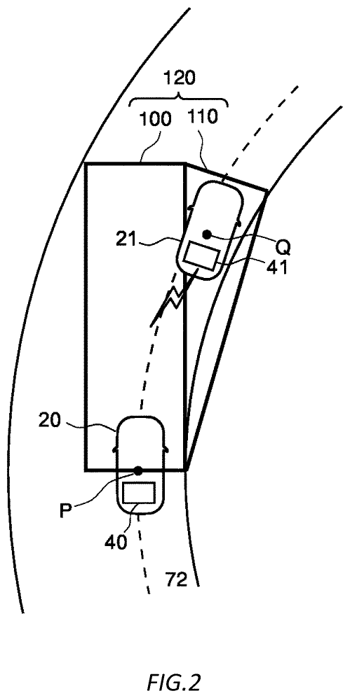

FIG. 2 shows a range of detection 120 which is set when a vehicle 20 is travelling on a curved road 72. When it is detected that the vehicle 20 is turning based on a travelling speed and a yaw rate of the vehicle 20, an assistance apparatus 40 sets a second range of detection 110, and sets a range obtained by adding the second range of detection 110 to a first range of detection 100 as the range of detection 120 where a travelling hazardous point is to be detected. The second range of detection 110 is a range located on a turning direction side of the vehicle 20 relative to the first range of detection 100. For example, when the vehicle 20 is turning to the right as shown in FIG. 2, the second range of detection 110 is a range located on a right side of the vehicle 20 relative to the first range of detection 100.

As a result, when the vehicle 20 is turning, the range of detection can be extended in a direction along a turning direction of the vehicle 20, compared to a case where the vehicle 20 is travelling straight. As a result, it is possible to avoid failing to detect a point Q, which is the travelling hazardous point.

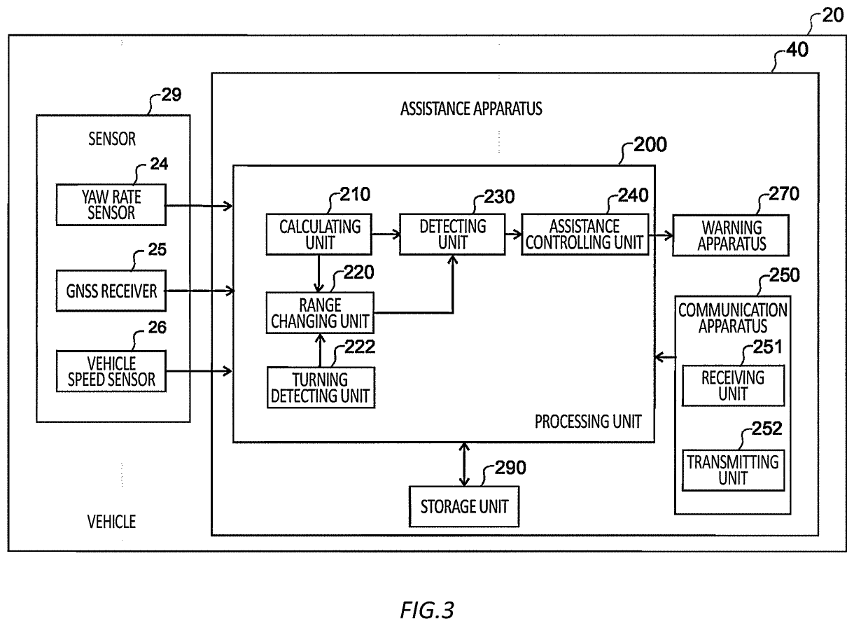

FIG. 3 shows a system configuration of a vehicle 20. The vehicle 20 includes a sensor 29, an assistance apparatus 40, a communication apparatus 250, and a warning apparatus 270.

The sensor 29 includes a yaw rate sensor 24, a GNSS receiver 25, a vehicle speed sensor 26, and the like. The vehicle speed sensor 26 detects a speed of the vehicle 20. The yaw rate sensor 24 detects a yaw rate of the vehicle 20. The GNSS receiver 25 obtains information on a current location of the vehicle 20 with a global navigation satellite system (GNSS). The warning apparatus 270 is equipment including, for example, a human machine interface (HMI) function. The communication apparatus 250 is responsible for communication with an outside of the vehicle 20. The communication apparatus 250 performs vehicle-to-vehicle communication through direct communication such as, for example, PC5. The communication apparatus 250 may perform communication with another vehicle by communicating through a base station of mobile communication. The communication apparatus 250 includes a receiving unit 251 and a transmitting unit 252.

The assistance apparatus 40 includes a processing unit 200 and a storage unit 290. The processing unit 200 is realized by, for example, an arithmetic processing apparatus including a processor. The storage unit 290 is realized including a non-volatile storage medium. The processing unit 200 performs processing by using information stored in the storage unit 290. The processing unit 200 may be realized by an electronic control unit (ECU) having a microcomputer including a CPU, ROM, RAM, I/O, a bus, and the like.

The processing unit 200 includes a calculating unit 210, a range changing unit 220, a detecting unit 230, and an assistance controlling unit 240.

The receiving unit 251 receives information indicating a travelling hazardous point which is transmitted from the outside of the vehicle 20. For example, the receiving unit 251 receives travelling hazardous point information transmitted from an assistance apparatus 41 included in a vehicle 21.

The calculating unit 210 calculates a distance and an azimuth from the vehicle 20 to the travelling hazardous point based on the travelling hazardous point and a current location of the vehicle 20. The detecting unit 230 detects the travelling hazardous point within a range of detection set ahead of the vehicle 20 in a running direction.

When the travelling hazardous point is detected within the range of detection, the assistance controlling unit 240 provides travelling assistance. For example, the assistance controlling unit 240 informs an occupant of the vehicle 20 of the presence of the travelling hazardous point through an HMI function included in the warning apparatus 270. It should be noted that the assistance controlling unit 240 may assist driving of the vehicle 20 itself. The assistance controlling unit 240 may assist control of a travelling speed of the vehicle 20. The assistance controlling unit 240 may assist steering of the vehicle 20.

A turning detecting unit 222 detects that the vehicle 20 is turning. The turning detecting unit 222 detects that the vehicle 20 is turning based on information detected by the yaw rate sensor 24 and the vehicle speed sensor 26. When it is detected by the turning detecting unit 222 that the vehicle 20 is turning, the range changing unit 220 extends the range of detection in a turning direction of the vehicle 20.

When it is detected by the turning detecting unit 222 that the vehicle 20 is turning, the range changing unit 220 extends the range of detection in the turning direction of the vehicle 20 by adding a second range of detection 110 to a first range of detection 100 which is set when it is detected by the turning detecting unit 222 that the vehicle 20 is not turning.

When it is detected by the turning detecting unit 222 that the vehicle 20 is turning, the smaller a turning radius of the vehicle 20 is, the more widely the range changing unit 220 may extend the range of detection in the turning direction of the vehicle 20.

When it is detected by the turning detecting unit 222 that the vehicle 20 is turning, the range changing unit 220 sets a point defining the second range of detection 110 at a location closer to a turning center than the first range of detection 100.

When it is detected by the turning detecting unit 222 that the vehicle 20 is turning, the smaller the turning radius of the vehicle 20 is, the closer the range changing unit 220 sets the point defining the second range of detection 110 at a location to the turning center than the first range of detection 100. The turning detecting unit 222 may detect the turning radius based on at least one of the speed and the yaw rate of the vehicle 20, a steering angle, a lateral acceleration, or locational information obtained with the GNSS.

When it is detected by the turning detecting unit 222 that the vehicle 20 is turning, the higher the speed of the vehicle 20 is, the farther the range changing unit 220 sets a point defining the second range of detection 110 from the vehicle 20. The higher the speed of the vehicle 20 is, the longer the first range of detection 100 is set to be in the running direction of the vehicle 20.

When it is sensed that a point where the vehicle 20 has travelled is hazardous for travelling, the transmitting unit 252 transmits, to an outside of the vehicle 20, the travelling hazardous point information indicating the point which has been sensed to be hazardous for travelling. For example, when deceleration exceeding a predetermined value is detected in the vehicle 20, the transmitting unit 252 transmits, to the outside of the vehicle 20, the travelling hazardous point information indicating a point where the deceleration exceeding the predetermined value is detected. When an object such as a pedestrian posing a hazard to a vehicle for travelling is detected around the vehicle 20, the transmitting unit 252 may transmit, to the outside of the vehicle 20, the travelling hazardous point information indicating a point where the detected object is. When a slip is detected with an ABS function of the vehicle 20, the transmitting unit 252 may transmit, to the outside of the vehicle 20, the travelling hazardous point information indicating a point where the slip is detected.

When the travelling assistance is provided, even if the receiving unit 251 receives the information indicating a new travelling hazardous point, the assistance controlling unit 240 may continue to provide the travelling assistance and suppress travelling assistance which is based on information indicating the new travelling hazardous point, until the vehicle 20 passes the travelling hazardous point.

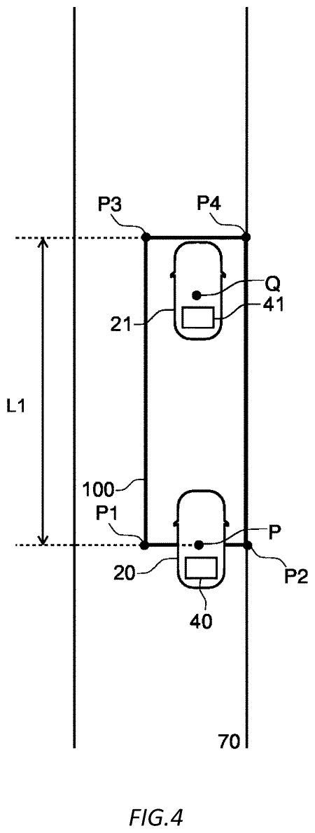

FIG. 4 is a diagram for describing a first range of detection 100 which is set when a vehicle 20 is travelling straight. The first range of detection 100 is a rectangular range defined by a point P1, a point P2, a point P3, and a point P4.

The point P1 and the point P2 are points set on both sides of a current location P of the vehicle 20 with respect to a travelling direction of the vehicle 20. The point P1 is a point set on a left side of the current location P with respect to the travelling direction of the vehicle 20. The point P2 is a point set on a right side of the current location P. The point P1 and the point P2 are set such that a line connecting the point P1 and the point P2 is orthogonal to a running direction. A distance between the point P1 and the point P2 may be set to a predetermined length. The point P1 and the point P2 may be set based on a width of a travelling lane of the vehicle 20. The distance between the point P1 and the point P2 may be set to be longer than at least the width of the travelling lane of the vehicle 20.

The point P3 is set at a location separated by L1 from the point P1 in the running direction of the vehicle 20. The point P4 is set at a location separated by L1 from the point P2 in the running direction of the vehicle 20. L1 is set according to a speed of the vehicle 20. The higher the speed of the vehicle 20 is, the longer L1 is set to be. L1 is set to be longer than a distance travelled by the vehicle 20 by the time when the speed of the vehicle 20 is reduced to a predetermined speed, when the vehicle 20 is decelerated at a predetermined deceleration rate.

Based on a distance and an azimuth from the vehicle 20 to a point Q as a travelling hazardous point which is calculated by a calculating unit 210 and on the current location P of the vehicle 20, a detecting unit 230 determines whether the point Q is included in the first range of detection 100. When the point Q is included in the first range of detection 100, an assistance controlling unit 240 provides travelling assistance. For example, the assistance controlling unit 240 informs an occupant of the vehicle 20 of information on the point Q through a warning apparatus 270.

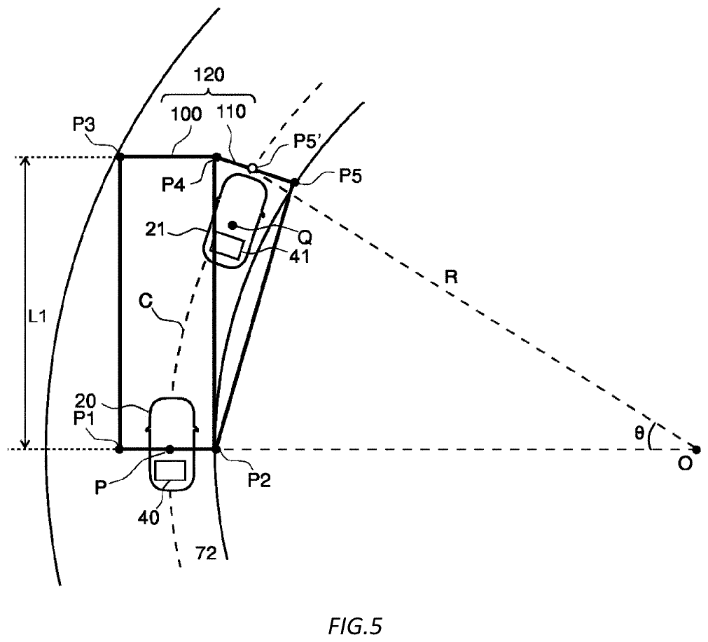

FIG. 5 is a diagram for describing a range of detection 120 which is set when a vehicle 20 is turning. A turning detecting unit 222 detects that the vehicle 20 is turning based on a yaw rate detected by a yaw rate sensor 24 and a speed detected by a vehicle speed sensor 26.

When it is detected by the turning detecting unit 222 that the vehicle 20 is turning, the range changing unit 220 sets a point P5 defining a second range of detection 110 at a location shifted in a turning direction from a point P4. In the example shown in FIG. 5, the range changing unit 220 sets the point P5 on a right side of the point P4 with respect to a running direction of the vehicle 20.

Specifically, the range changing unit 220 calculates a turning curvature radius R of the vehicle 20 based on the yaw rate detected by the yaw rate sensor 24 and the speed detected by the vehicle speed sensor 26. The range changing unit 220 sets a circle C with the radius R which passes through a current location P of the vehicle 20. The range changing unit 220 sets a point P5′ at a location advanced by L1 along the circle C from the current location P of the vehicle 20. For example, with a turning center of the vehicle 20 as O, the range changing unit 220 calculates the point P5′ by calculating an angle θ formed by P-O-P5′ based on the curvature radius and L1.

The range changing unit 220 sets the point P5 on a straight line passing through the point P4 and the point P5′. The range changing unit 220 may set a distance between the point P4 and the point P5 to a predetermined distance. The range changing unit 220 may set the distance between the point P4 and the point P5 based on a width of a travelling lane of the vehicle 20. The range changing unit 220 may set the distance between the point P4 and the point P5 to be longer than at least the width of the travelling lane of the vehicle 20. The range changing unit 220 sets, as the range of detection 120, a polygon range defined by a point P1, a point P2, the point P5, the point P4, and a point P3.

As a result, when the vehicle 20 is turning, the range of detection can be extended in the turning direction of the vehicle 20, compared to a case where the vehicle 20 is travelling straight. As a result, it is possible to avoid failing to detect a point Q, which is a travelling hazardous point ahead in the running direction, when the vehicle 20 is turning.

According to the method for setting the point P5 described with reference to FIG. 5, since the smaller the turning radius R is, the greater the angle θ is, the smaller the turning radius R is, the farther inward the point P5 can be set in the turning direction than a first range of detection 100. That is, the smaller the turning radius is, the closer the point P5 can be set at a location to a turning center O than the first range of detection 100. In this manner, the smaller the turning radius R is, the wider the second range of detection 110 can be in the turning direction of the vehicle 20. In this manner, since the range changing unit 220 can set the second range of detection 110 according to the turning radius of the vehicle 20, it is possible to avoid failing to detect the point Q, which is the travelling hazardous point ahead in the running direction, when the vehicle 20 is turning.

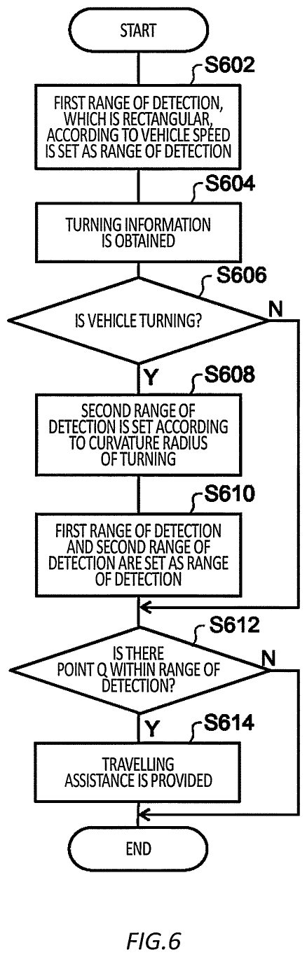

FIG. 6 shows one example of a flowchart regarding an assistance method executed by an assistance apparatus 40. Processing of the present flowchart is repeatedly executed in a vehicle 20. The processing of the present flowchart may be executed after travelling hazardous point information is received. The processing of the present flowchart may be repeatedly executed after the travelling hazardous point information is received.

In S602, a range changing unit 220 sets a first range of detection 100, which is rectangular, according to a speed of the vehicle 20 as a range of detection. The higher the speed of the vehicle 20 is, the longer the first range of detection 100 is set to be along a travelling direction of the vehicle 20.

In S604, a turning detecting unit 222 obtains turning information of the vehicle 20. For example, the turning detecting unit 222 obtains information indicating a yaw rate and a vehicle speed from a sensor 29. The turning detecting unit 222 may obtain, as the turning information of the vehicle 20, a steering angle of the vehicle 20, a lateral acceleration, and a temporal change in locational information of the vehicle 20 obtained with a GNSS.

In S606, the turning detecting unit 222 determines, based on the turning information, whether the vehicle 20 is turning. If it is determined in S606 that the vehicle 20 is not turning, it is determined in S612 whether there is a point Q within the range of detection set in S602. If it is determined that the point Q is within the range of detection set in S602, travelling assistance is provided in S614, and the processing of the present flowchart ends.

If it is determined in S606 that the vehicle 20 is turning, the range changing unit 220 sets a second range of detection 110 according to a curvature radius R of the turning in S608. In S610, the range changing unit 220 sets the first range of detection 100 and the second range of detection 110 as the range of detection. Subsequently, it is determined in S612 whether the point Q is within the range of detection set in S610. If it is determined that the point Q is within the range of detection set in S610, the travelling assistance is provided in S614, and the processing of the present flowchart ends.

According to the assistance apparatus 40 describe above, when the vehicle 20 is turning, the range of detection of a travelling hazardous point can be set to be wide in a turning direction. Therefore, it is possible to set the range of detection not to be excessively wide while reducing a possibility of failing to provide the travelling assistance. As a result, it is possible to more appropriately inform an occupant of the vehicle 20 of information on a point which may be hazardous to the vehicle 20 for travelling, such as a point where a preceding vehicle has rapidly decelerated, or a point where the preceding vehicle has slipped.

In the present embodiment, it is assumed that the travelling hazardous point information is transmitted and received through vehicle-to-vehicle communication. However, a configuration may be adopted in which a server retaining the travelling hazardous point information is further provided. For example, when receiving the travelling hazardous point information transmitted from each vehicle, the server may retain the travelling hazardous point indicated by the travelling hazardous point information for a predetermined period of time. The server may transmit, to a vehicle travelling toward the travelling hazardous point, the retained information indicating the travelling hazardous point. A vehicle travelling at a location away from another vehicle which has detected the travelling hazardous point may be unable to receive the travelling hazardous point information through the vehicle-to-vehicle communication, but providing the server retaining the travelling hazardous point information can more reliably provide the travelling hazardous point information to the vehicle.

It should be noted that the vehicle 20 is a vehicle as one example of transportation equipment. The vehicle may be an automobile such as an automobile including an internal combustion engine, an electric automobile, or a fuel-cell vehicle (FCV). The automobile includes a bus, a truck, a two-wheeled vehicle, or the like. The vehicle may be a saddled vehicle or the like, or may be a motorcycle. The transportation equipment includes, in addition to the vehicle, equipment such as a ship and an aircraft including an unmanned aircraft. The transportation equipment may be any equipment to transport humans or goods. The transportation equipment is one example of a moving body. The moving body is not limited to the transportation equipment, and may be any movable equipment.

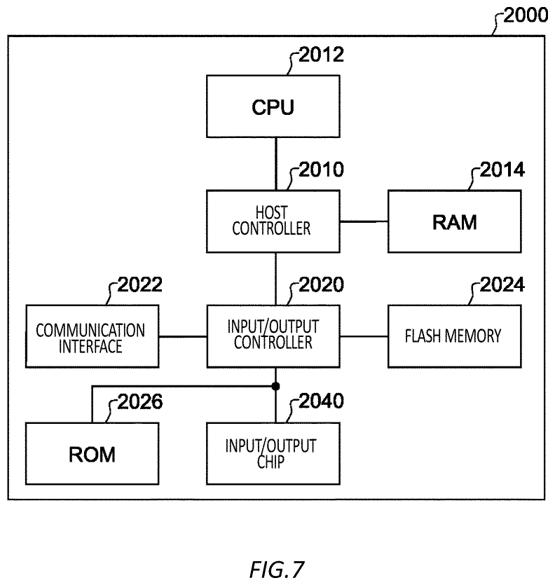

FIG. 7 shows an example of a computer 2000 in which a plurality of embodiments of the present invention may be entirely or partially embodied. A program installed in the computer 2000 can cause the computer 2000 to: function as a system according to the embodiments or each unit of the system or an apparatus such as the assistance apparatus 40 or each unit of the apparatus; execute operations associated with the system or each unit of the system or the apparatus or each unit of the apparatus; and/or execute a process according to the embodiments or steps of the process. Such a program may be executed by a CPU 2012 in order to cause the computer 2000 to execute a specific operation associated with some or all of the processing procedures and the blocks in the block diagrams described in the present specification.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to a program stored in the ROM 2026 and the RAM 2014, thereby controlling each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

Programs are provided via a network or a computer readable storage medium such as a CD-ROM, a DVD-ROM, or a memory card. The RAM 2014, the ROM 2026, or the flash memory 2024 is an example of the computer readable storage medium. The programs are installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be configured by realizing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, when a plurality of entries each having an attribute value of a first attribute associated with an attribute value of a second attribute, is stored in the recording medium, the CPU 2012 may search for an entry having a designated attribute value of the first attribute that matches a condition from these plurality of entries, and read the attribute value of the second attribute stored in this entry, thereby obtaining the attribute value of the second attribute associated with the first attribute that satisfies a predetermined condition.

The programs or software module described above may be stored on the computer 2000 or in a computer readable storage medium near the computer 2000. A recording medium such as a hard disk or a RAM provided in a server system connected to a dedicated communication network or the Internet can be used as the computer readable storage medium. The programs stored in the computer readable storage medium may be provided to the computer 2000 via a network.

The programs installed onto the computer 2000 for causing the computer 2000 to function as the assistance apparatus 40 may instruct the CPU 2012 or the like to cause the computer 2000 to function as each unit of the assistance apparatus 40. The information processing written in these programs are read by the computer 2000 to cause the computer to function as each unit of the assistance apparatus 40, which is specific means realized by the cooperation of software and the various kinds of hardware resources described above. These specific means realize arithmetic operations or processing of information according to the intended use of the computer 2000 in the present embodiment, and the assistance apparatus 40 is thereby constructed to be specific for the intended use.

Various embodiments have been described with reference to the block diagrams and the like. In the block diagrams, each block may represent (1) a step of a process in which an operation is executed, or (2) each unit of the apparatus responsible for executing the operation. A specific step and each unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer readable storage medium may include any tangible device capable of storing instructions to be executed by an appropriate device, so that the computer readable storage medium having instructions stored therein constitutes at least a part of a product including instructions which may be executed to provide means for executing processing procedures or operations designated in the block diagrams. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer readable instructions may be provided to a processor of a general purpose computer, a special purpose computer, or another programmable data processing apparatus, or to programmable circuit, locally or via a local area network (LAN), wide area network (WAN) such as the Internet, and a computer readable instruction may be executed to provide means for executing operations designated in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

It should be noted that the operations, procedures, steps, steps, and the like of each process executed by an apparatus, system, program, and method shown in the claims, embodiments, or diagrams can be realized in any order as long as the order is not indicated by “prior to,” “before,” or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

20: vehicle
29: sensor
24: yaw rate sensor
25: GNSS receiver
26: vehicle speed sensor
40: assistance apparatus
100: first range of detection
110: second range of detection
120: range of detection
200: processing unit
210: calculating unit
220: range changing unit
222: turning detecting unit
230: detecting unit
240: assistance controlling unit
250: communication apparatus
251: receiving unit
252: transmitting unit
270: warning apparatus
290: storage unit
2000: computer
2010: host controller
2012: CPU
2014: RAM
2020: input/output controller;
2022: communication interface
2024: flash memory
2026: ROM
2040: input/output chip.

What is claimed is:

1. An assistance apparatus comprising:
a receiving unit which receives information indicating a travelling hazardous point which is transmitted from an outside of a vehicle;
a calculating unit which calculates a distance and an azimuth from the vehicle to the travelling hazardous point based on the travelling hazardous point and a current location of the vehicle;
a detecting unit which detects the travelling hazardous point within a range of detection set ahead of the vehicle in a running direction;
an assistance controlling unit which provides travelling assistance when the travelling hazardous point is detected within the range of detection;
a turning detecting unit which detects that the vehicle is turning; and
a range changing unit which extends the range of detection in a turning direction of the vehicle when it is detected by the turning detecting unit that the vehicle is turning.

2. The assistance apparatus according to claim 1, wherein
when it is detected by the turning detecting unit that the vehicle is turning, the range changing unit extends the range of detection in the turning direction of the vehicle by adding a second range of detection to a first range of detection which is set when it is detected by the turning detecting unit that the vehicle is not turning.

3. The assistance apparatus according to claim 1, wherein
when it is detected by the turning detecting unit that the vehicle is turning, the smaller a turning radius of the vehicle is, the more widely the range changing unit extends the range of detection in the turning direction of the vehicle.

4. The assistance apparatus according to claim 2, wherein
when it is detected by the turning detecting unit that the vehicle is turning, the range changing unit sets a point defining the second range of detection at a location closer to a turning center than the first range of detection.

5. The assistance apparatus according to claim 4, wherein
when it is detected by the turning detecting unit that the vehicle is turning, the smaller a turning radius of the vehicle is, the closer the range changing unit sets the point defining the second range of detection at a location to the turning center than the first range of detection.

6. The assistance apparatus according to claim 5, wherein
when it is detected by the turning detecting unit that the vehicle is turning, the higher a speed of the vehicle is, the farther the range changing unit sets the point defining the second range of detection from the vehicle.

7. The assistance apparatus according to claim 6, wherein
the higher the speed of the vehicle is, the longer the first range of detection is set to be in the running direction of the vehicle.

8. The assistance apparatus according to claim 3, wherein
the turning detecting unit detects the turning radius based on at least one of a yaw rate and vehicle speed, a steering angle, a lateral acceleration, or locational information which is based on a GNSS.

9. The assistance apparatus according to claim 2, wherein
when it is detected by the turning detecting unit that the vehicle is turning, the smaller a turning radius of the vehicle is, the more widely the range changing unit extends the range of detection in the turning direction of the vehicle.

10. The assistance apparatus according to claim 9, wherein
when it is detected by the turning detecting unit that the vehicle is turning, the range changing unit sets a point defining the second range of detection at a location closer to a turning center than the first range of detection.

11. The assistance apparatus according to claim 10, wherein
when it is detected by the turning detecting unit that the vehicle is turning, the smaller a turning radius of the vehicle is, the closer the range changing unit sets the point defining the second range of detection at a location to the turning center than the first range of detection.

12. The assistance apparatus according to claim 11, wherein
when it is detected by the turning detecting unit that the vehicle is turning, the higher a speed of the vehicle is, the farther the range changing unit sets the point defining the second range of detection from the vehicle.

13. The assistance apparatus according to claim 2, wherein
the higher a speed of the vehicle is, the longer the first range of detection is set to be in the running direction of the vehicle.

14. The assistance apparatus according to claim 4, wherein
the higher a speed of the vehicle is, the longer the first range of detection is set to be in the running direction of the vehicle.

15. The assistance apparatus according to claim 5, wherein
the higher a speed of the vehicle is, the longer the first range of detection is set to be in the running direction of the vehicle.

16. The assistance apparatus according to claim 1, wherein
the travelling hazardous point is detected within the range of detection based on the distance and the azimuth from the vehicle to the travelling hazardous point calculated by the calculating unit.

17. The assistance apparatus according to claim 3, wherein
the travelling hazardous point is detected within the range of detection based on the distance and the azimuth from the vehicle to the travelling hazardous point calculated by the calculating unit.

18. A vehicle comprising the assistance apparatus according to claim 1.

19. An assistance method comprising:
receiving information indicating a travelling hazardous point which is transmitted from an outside of a vehicle;
calculating a distance and an azimuth from the vehicle to the travelling hazardous point based on the travelling hazardous point and a current location of the vehicle;
detecting the travelling hazardous point within a range of detection set ahead of the vehicle in a running direction;
providing travelling assistance when the travelling hazardous point is detected within the range of detection;
detecting that the vehicle is turning; and
extending the range of detection in a turning direction of the vehicle when it is detected that the vehicle is turning.

20. A non-transitory computer readable storage medium having stored thereon a program that causes a computer to function as:
a receiving unit which receives information indicating a travelling hazardous point which is transmitted from an outside of a vehicle;
a calculating unit which calculates a distance and an azimuth from the vehicle to the travelling hazardous point based on the travelling hazardous point and a current location of the vehicle;
a detecting unit which detects the travelling hazardous point within a range of detection set ahead of the vehicle in a running direction;
an assistance controlling unit which provides travelling assistance when the travelling hazardous point is detected within the range of detection;
a turning detecting unit which detects that the vehicle is turning; and
a range changing unit which extends the range of detection in a turning direction of the vehicle when it is detected by the turning detecting unit that the vehicle is turning.
